(19) United States
(12) Patent Application Publication
(10) Pub. No.: US 2006/0180203 A1
(43) Pub. Date: Aug. 17, 2006

(54) THERMODYNAMIC STEAM TRAP

(75) Inventor: E. Michael Stamatakis, St. Louis, MO (US)

Correspondence Address: SENNIGER POWERS, ONE METROPOLITAN SQUARE, 16TH FLOOR, ST LOUIS, MO, 63102, US

(73) Assignee: STEAM TECH, INC., St. Louis, MO (US)

(21) Appl. No.: 10/906,389

(22) Filed: Feb. 17, 2005

(51) Int. Cl. F16T 1/00

(52) U.S. Cl. 137/183

(57) ABSTRACT

A steam restricter adapted to be retrofitted into an existing steam trap having a chamber, an inlet for admitting steam and condensate into the chamber and a drain for draining condensate. The steam restricter includes a body having an inlet passage and a cavity in the body, the inlet passage in the body extending to the cavity. A drain outlet passage extends from the cavity for passing condensate from the cavity to the drain of the steam trap. A thermodynamic stop disk is disposed in the cavity for movement between an open position in which the stop disk permits fluid communication through the cavity from the inlet passage to the outlet passage and a closed position in which the stop disk blocks communication from the inlet passage to the outlet passage. A mating base includes an outlet passage that opens into the steam trap drain.

### BACKGROUND OF THE INVENTION

This invention relates generally to condensate removal devices in gas piping systems, and more particularly to a variable load steam trap that can be retrofitted into pre-existing steam traps.

Steam is an efficient and widely used heat transfer medium for transporting energy. An unavoidable by-product when using steam is liquid condensate (i.e., water) that forms when heat is transferred away from steam along pipes or at heat exchangers. When condensate collects inside pipes or other components, system efficiency is significantly degraded. Condensate also can cause a destructive water hammer, a shock wave that damages components and can cause serious injury to people nearby. Accordingly, condensate should be removed from steam systems as it forms.

A steam trap is a mechanical device used to drain condensate while retaining or “trapping” steam. Traps are typically positioned at natural low points in steam systems where condensate collects or ahead of control valves where condensate could impede proper valve operation. Most traps operate using the inherent difference in density between liquid and gas to separate the fluids. Ideally, each trap should be capable of draining a massflow, or load, of condensate that flows to its location in the steam system. Each trap should also be reliable in operation to avoid costly inefficiencies that arise when condensate collects or when live steam is released from a defective trap. Several types of steam traps are commonly available. Some are complex in design and subject to fail without frequent maintenance.

Many steam systems are of very old design and contain highly inefficient condensate traps. Moreover, these traps may have mechanical parts that are prone to failure. Accordingly, it is desirable to replace or augment these traps with steam restricters that are efficient and reliable.

One type of trap that is economical and reliable is a fixed orifice trap. A relatively small hole or tubular passageway in a trap permits condensate to drain through. These traps are comparatively inexpensive and there are no moving parts to corrode or fail. They are very effective in draining condensate while preventing release of live steam. The condensate flowing in a fixed orifice generally blocks entry of steam. An example of a steam restricter device having a fixed orifice configuration is shown in co-assigned U.S. Pat. No. 5,088,518, the disclosure of which is incorporated herein by reference. This device is particularly suited for retrofitting into existing steam traps because it is compact.

A drawback to fixed orifice traps is that they cannot accept large variations in condensate load. The diameter of the orifice is fixed, and therefore the capacity of the trap, which is proportional to area of the orifice and the flow velocity, is also substantially fixed. Orifices are sized to drain an expected load. The actual load, however, can increase by a factor of four or more if ambient temperature decreases and/or air is forced over a steam heat exchanger, causing heat transfer rates from the steam to increase and causing formation of a larger quantity of condensate. In the past, this has been partially compensated for by over-sizing the orifice for the particular application. An over-sized orifice not only passes more load, but possesses a valuable secondary benefit of a greater ability to pass solid debris. Small deposits of corrosion or other particulate matter may become mixed within the flow of condensate and can clog the trap. There is less tendency for solid particles to lodge in an orifice or passageway that is relatively larger. However, a trap having an orifice that is larger than needed for ordinary loads tends to permit release of live steam and is inefficient.

A second type of trap is a thermodynamic or disk type trap. An obstruction comprising a flat disk is captured within the trap but is movable in the trap between a closed position in which the disk blocks flow of fluid through the trap, and an open position in which the disk permits flow of fluid. The disk may cycle between open and closed positions, and when in the open position the trap is capable of handling a greater quantity of condensate load than a fixed orifice trap. Condensate flow initially raises the disk open as it flows in, effectively increasing the orifice size for larger volumes of condensate. When steam enters the volume around the disk, it changes the local pressure and lowers the disk, closing the trap, which stays closed as long as relatively higher pressure is maintained above the disk. An example of thermodynamic trap is shown in co-assigned U.S. Pat. No. 6,148,844, the disclosure of which is incorporated herein by reference.

Thermodynamic traps require some space in which to operate because of the movement of the disk and the size of the openings. Accordingly, thermodynamic traps are not retrofit into existing traps, but are added onto steam systems as separate and complete steam traps making no use of the existing structure, or are incorporated as part of new steam systems. Thus, conversion to a thermodynamic trap has heretofore required either a complete replacement of the existing trap, or replacement of the entire steam system.

### SUMMARY OF INVENTION

In general, a steam restricter of the present invention is adapted to be retrofitted into an existing steam trap having a chamber, an inlet for admitting steam and condensate into the chamber and a drain for draining condensate from the chamber to a condensate return. The steam restricter generally comprises a body having an inlet passage positioned for opening to the chamber of the steam trap when installed in the steam trap and a cavity in the body, the inlet passage in the body extending to the cavity. A drain outlet passage extends from the cavity for passing condensate from the cavity to the drain of the steam trap when installed therein. A thermodynamic stop disk is disposed in the cavity for movement in the cavity relative to the body between an open position in which the stop disk permits fluid communication through the cavity from the inlet passage to the outlet passage and a closed position in which the stop disk blocks communication from the inlet passage to the outlet passage. A mating base is sized and shaped for connection to the drain of the steam trap so that passage of fluid in the steam trap to the drain is blocked except through the steam restricter when installed in the steam trap. The outlet passage extends through the mating base and opens into the steam trap drain when installed in the steam trap.

In another aspect of the invention, the steam restricter is capable of handling variable condensate loads and is compact for installation in small spaces. The steam restricter generally comprises a body having a central axis and an inlet passage including first and second inlet passage members for receiving steam and condensate into the body and a cavity in the body. The second inlet passage member extends parallel to the central axis of the body to a mouth where the second inlet passage member opens into the cavity. A drain outlet passage includes a drain passage member adapted for fluid communication with the cavity. The drain passage member extends parallel to the central axis of the body to a port. The cavity and port are at least partially in registration with each other along the central axis of the body. A thermodynamic stop disk is disposed in the cavity for movement relative to the body between an open position in which the stop disk permits fluid communication through the cavity from the second inlet passage member to the drain passage member and a closed position in which the stop disk blocks fluid communication from the second inlet passage member to the drain passage member.

Other objects and features of the present invention will be in part apparent and in part pointed out hereinafter.

### BRIEF DESCRIPTION OF THE DRAWINGS

FIG. 1 is a schematic of a forced air steam heater;

FIG. 2 is a schematic cross-section of the heater of FIG. 1;

FIG. 3 is a cross section of a steam trap including a steam restricter of the present invention;

FIG. 4 is an exploded perspective of the steam restricter removed from the steam trap;

FIG. 5 is a vertical section of the steam restricter;

FIG. 6 is an exploded vertical section of the steam restricter;

FIG. 7 is a cross-section taken along the plane including line 7—7 of FIG. 5;

FIG. 8 is a side elevation of a cylindrical portion of a body of the steam restricter;

FIG. 9 is a top view of the cylindrical portion;

FIG. 10 is a bottom view of the cylindrical portion;

FIG. 11 is a perspective of a steam restricter retrofit kit; and

FIG. 12 is a vertical section of a second embodiment of the steam restricter.

Corresponding reference characters indicate corresponding parts throughout the several views of the drawings.

### DETAILED DESCRIPTION OF THE PREFERRED EMBODIMENTS

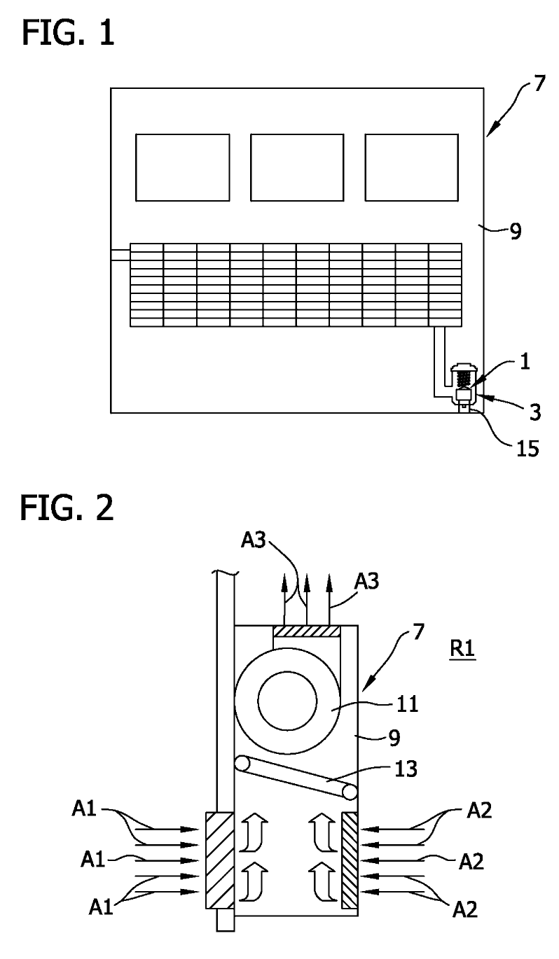

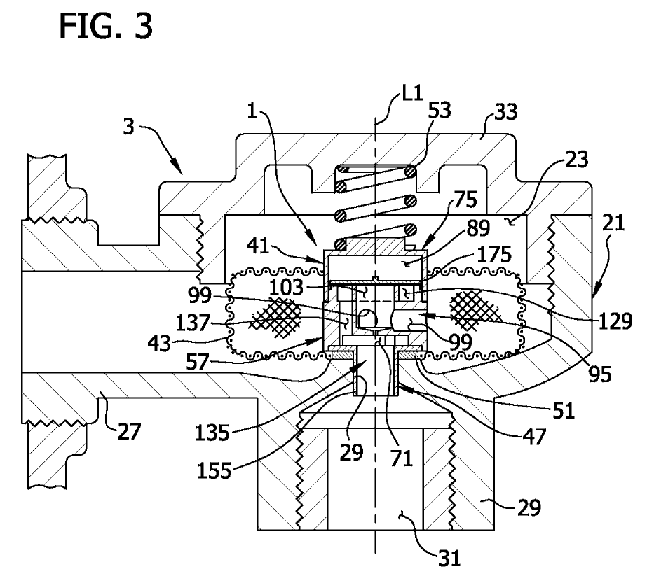

Referring now to the drawings, and in particular FIGS. 1 and 3, a steam restricter of the present invention, indicated generally at 1, is constructed so as to be easily retrofitted into an existing steam trap, generally indicated 3, of a forced air steam heater 7 (FIGS. 1 and 2). In the illustrated embodiment, the heater 7 includes a housing 9 enclosing a fan 111 and a steam coil 13 that receives steam from steam piping (not shown). As shown in FIG. 2, the fan 11 operates to draw in outside air, indicated by arrows A1, and return air, indicated by arrows A2, from the room R1 being heated and discharges air, indicated by arrows A3, that has been heated by the steam coil 13. During the heat exchange process, condensate (not shown) collects in the steam trap 3 connected to the steam coil 13 and is removed from the steam piping by flow through a condensate return line 15. Removal of the condensate from the steam piping is needed to maintain performance of the heater 7. The steam restricter 1 of the present invention is installed in the steam trap 3 to control the removal of condensate from the trap and prevent the loss of steam from the steam piping supplying steam to the steam coil 13. It is understood that the steam restricter 1 may be installed on a conventional convection steam radiator heating system, or on systems using steam for purposes other than heating without departing from the scope of this invention. Furthermore, the steam restricter 1 of the present invention may be installed as a retrofit for an existing steam trap 3 or may be incorporated as a component of a steam trap assembly supplied for installation with a new heater 7.

As shown in FIG. 3 the steam trap 3 includes a collecting bowl, generally indicated 21, defining a chamber 23 for receiving condensate and containing the steam restricter 1. The bowl 21 has an inlet 27 connected to the heater 7 (FIG. 1) for admitting steam and condensate into the chamber 23 and a drain 29 having an outlet passage 31 at the bottom of the bowl for the passage of condensate from the chamber to the condensate return 15 (FIG. 1). Condensate is returned to the boiler (not shown) that supplies steam to the steam coil 13 in the heater 7 via the condensate return 15. A removable cover 33 defines the upper wall of the steam trap 3 and is threadably attached to the collecting bowl 21 to enclose the chamber 23 and allow access to the chamber by removing the cover.

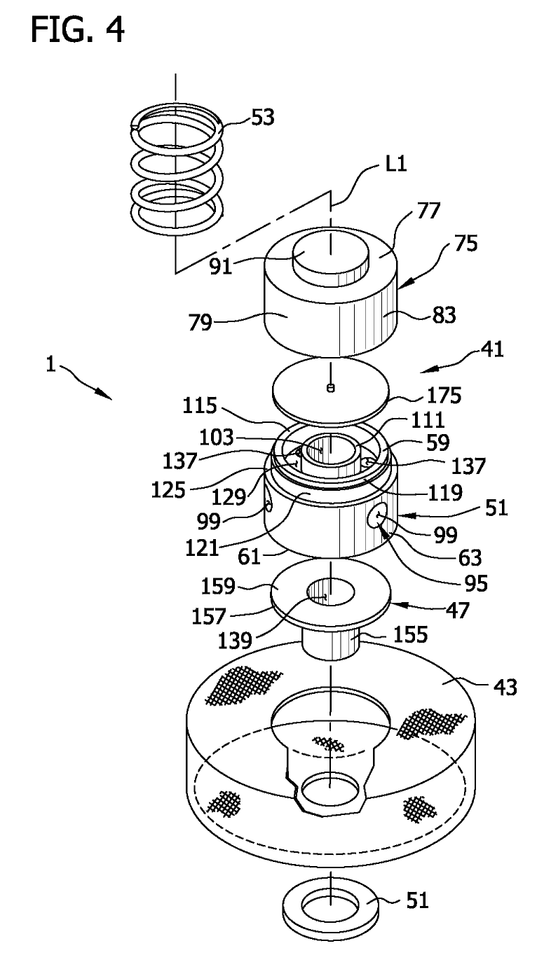

As shown in FIGS. 3 and 4, the steam restricter 1 has a central longitudinal axis L1 and includes a body, generally indicated 41, received in an annular filter 43 in the chamber 23 (FIG. 3). The annular filter 43 is made of corrosion resistant wire mesh so as to prevent the ingress of debris (e.g., rust, small pipe fragments, etc.) into the body 41. A mating base, generally indicated 47, at the bottom surface of the body 41 is sized and shaped for connection to the drain 29 of the steam trap 3 (FIG. 3) to force fluid in the steam trap to flow through the restricter 1. A gasket 51 between the mating base 47 and the drain 29 prevents the flow of fluid between the restricter 1 and the drain of the steam trap 3. A coil spring 53 housed in the chamber 23 applies a downward force acting on the steam restricter 1 that presses the mating base 47 against the gasket 51 surrounding the drain 29 of the steam trap 3 to prevent the passage of fluid between the restricter and the drain. A filter (not shown) may be more elongated along its axis of rotation so that it can extend up to the cover 33 and surround the spring 53. Filters of different sizes and shapes may be used, or the filter may be omitted within the scope of the present invention.

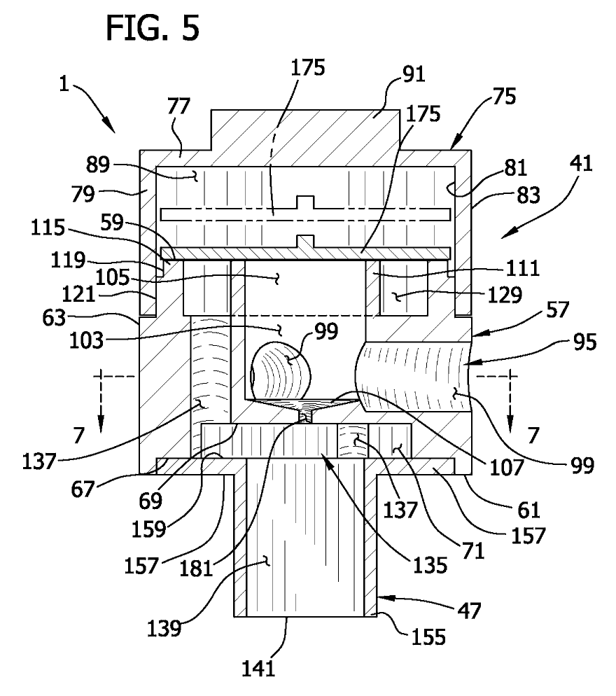

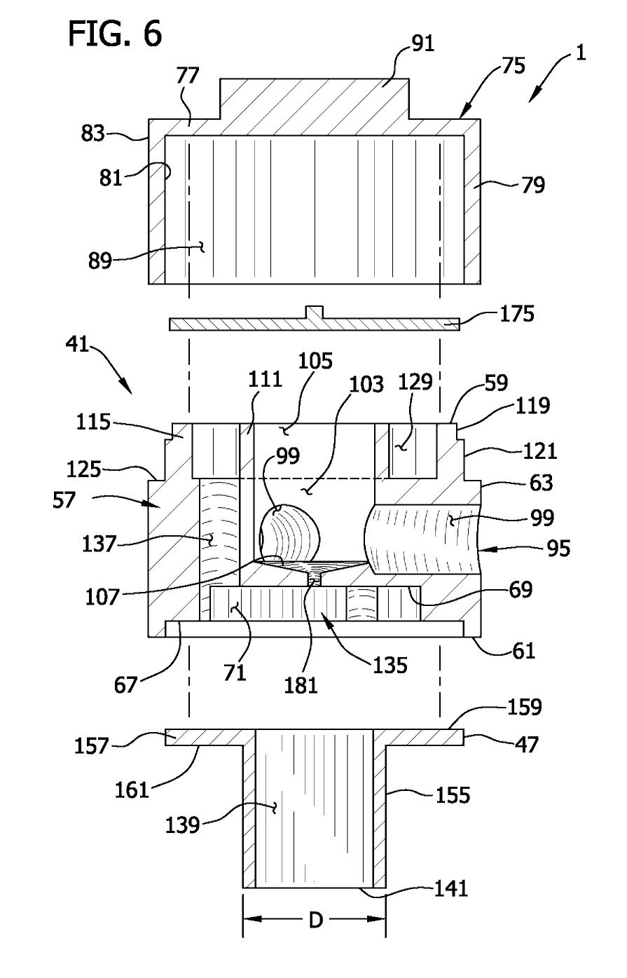

As shown in FIGS. 4-6, the body 41 includes a cylindrical portion, generally indicated 57, having a top surface 59, a bottom surface 61, and a side surface 63. As shown in FIGS. 5 and 6, the bottom surface 61 has an outer annular recess 67 sized for receiving the mating base 47 and a central recess 69 that forms a manifold 71 at the bottom of the cylindrical portion 57. The body 41 includes a cap, generally indicated 75, separate from the cylindrical portion 57 and releasably connected to top surface 59. The cap 75 has a top wall 77 and a cylindrical side wall 79 extending downward from the top wall. The cylindrical side wall 79 of the cap 75 has an inner surface 81 and an outer surface 83. The cap 75 is shaped to receive a top portion of the cylindrical portion 57 of the body 41 and define a cavity, generally indicated 89, between the top surface 59 of the cylindrical portion and the top wall 77 of the cap. In the illustrated embodiment, the top wall 77 of the cap 75 has a cylindrical protrusion 91 that is received by the coil spring 53 (FIG. 4) housed in the chamber 23 (FIG. 3) of the steam trap 3. As shown in FIG. 3, the coil spring 53 acts against the cover 33 of the steam trap 3 and biases the cap 75 downward forcing the body 41 into sealing engagement with the mating base 47. It is understood that the cap 75 may have a generally flat top wall 77 without the protrusion 91 so that the overall height of the steam restricter 1 is reduced.

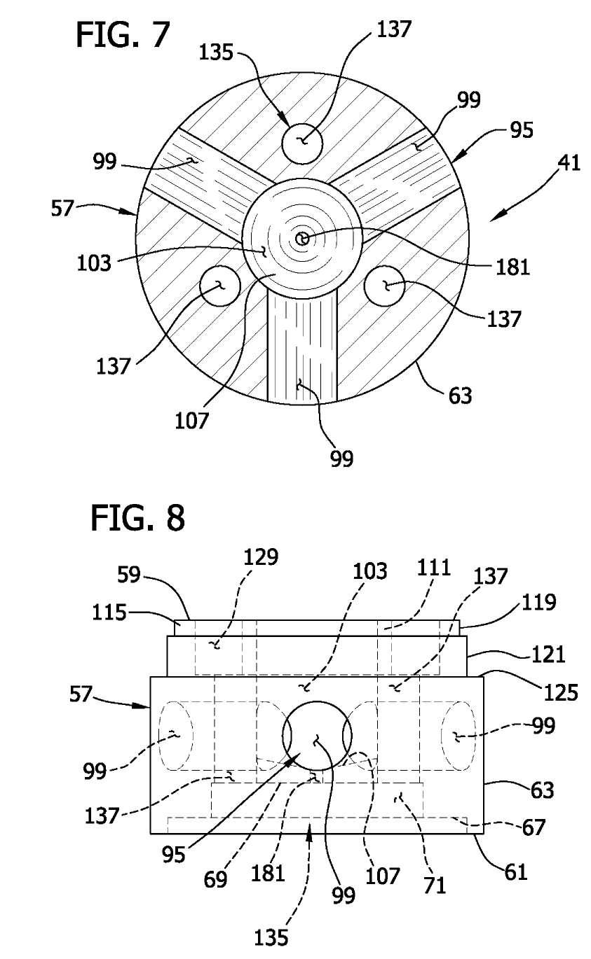

The body 41 has an inlet passage, generally indicated 95, in the cylindrical portion 57 opening from the chamber 23 of the steam trap 3 to allow fluid to enter the body. In the illustrated embodiment, the inlet passage 95 comprises three first inlet passage members 99 (two of which are shown in FIGS. 3-6) opening from the side surface 63 of the cylindrical portion 57 to receive fluid from the chamber 23 of the steam trap 3. As shown in FIG. 7, the inlet passage members 99 are generally cylindric passages extending generally radially of the body 41. The inlet passage members 99 are spaced apart an approximately equal angular distance (e.g., 120 degrees) around the circumference of the body 41. The number of inlet passage members 99 may be other than three without departing from the scope of the present invention.

The inlet passage 95 includes a second inlet passage member, generally indicated 103, in the cylindrical portion 57 of the body 41 in fluid communication with the three first inlet passage members 99. In the illustrated embodiment, the second inlet passage member 103 is an axial bore in the cylindrical portion 57 of the body 41 that is coaxial with the central longitudinal axis L1 of the steam restricter 1. As shown in FIGS. 5 and 6, the second inlet passage member 103 has a top portion (mouth) 105 that opens at the top surface 59 of the cylindrical portion 57 for fluid communication with the cavity 89. The second inlet passage member 103 has a conical bottom wall 107 spaced above the bottom surface 61 of the cylindrical portion 57.

Referring to FIGS. 4-6, the top of the cylindrical portion 57 of the body 41 has an inner annular wall 111 that defines the top portion 105 of the second inlet passage member 103 and an outer annular wall 115 radially spaced from the inner annular wall. The outer annular wall 115 has an upper side surface 119 inwardly offset from a lower side surface 121. The cylindrical portion 57 has an outer annular shoulder 125 adjacent the lower side surface 121 of the outer annular wall 115 and the side surface 63 of the cylindrical portion 57. The cylindrical side wall 79 of the cap 75 is shaped to receive the outer annular wall 115 of the cylindrical portion 57 to enclose the cavity 89 of the steam restricter 1. The lower side surface 121 of the outer annular wall 115 and the inner surface 81 of the cylindrical side wall 79 of the cap 75 may have mating threads (not shown) so that the cap may be threadably connected to the cylindrical portion 57 of the body 41. The top surface 59 of the cylindrical portion 57 has an annular channel 129 between the inner annular wall 111 and the outer annular wall 115 that defines a lower portion of the cavity 89.

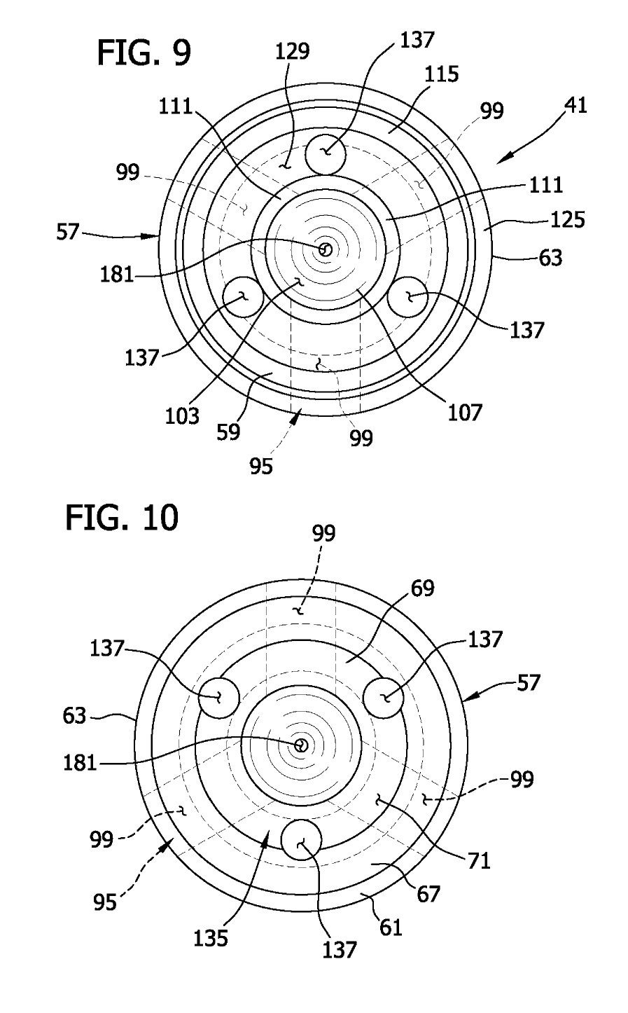

A drain outlet passage, generally indicated 135, is in fluid communication with the cavity 89 for passing condensate from the cavity to the drain 29 of the steam trap 3. The drain outlet passage 135 includes three cavity passage members 137 (two of which are shown in FIGS. 4-6), the manifold 71 at the bottom of the cylindrical portion 57 of the body 41, and a drain passage member 139 in the mating base 47. As shown in FIGS. 4 and 9, the three cavity passage members 137 each open from the annular channel 129 of the cylindrical portion 57 and extend generally vertically though the cylindrical portion of the body 41 to the manifold 71 at the bottom of the cylindrical portion. The cavity passage members 137 allow fluid communication between the lower portion 129 of the cavity 89 and the manifold 71 at the bottom of the body 41. As shown in FIG. 7, the cavity passage members 137 are angularly spaced between the first inlet passage members 99 that pass radially through the body 41. In one embodiment, the combined cross-sectional area of the three cavity passage members 137 is equivalent to the cross-sectional area of the second inlet passage member 103 so that fluid flow from the second inlet passage member to the manifold 71 is not restricted.

The manifold 71 of the outlet passage 135 at the bottom of the cylindrical portion 57 is in fluid communication with the drain passage member 139 in the mating base 47 so that fluid can pass from the manifold to the drain 29 of the steam trap 3. In the illustrated embodiment, the drain passage member 139 extends parallel to the central axis L1 of the body 41 through the mating base 47 to a port 141 that opens into the drain 29 of the steam trap 3 to allow condensate to exit the steam restricter 1 and flow into the condensate return 15. The port 141 of the drain passage member 139 is in registration with the cavity 89 to allow condensate to flow from the cavity into the drain 29 via the drain outlet passage 135.

As shown in FIG. 6, the mating base 47 is generally tubular with a tubular lower portion 155 that defines the drain passage member 139 and has an outer diameter D. The mating base 47 has a flange 157 for connection to the cylindrical portion 57 of the body 41. The flange 157 is sized for being received in the outer annular recess 67 and has an upper surface 159 in contact with the outer annular recess of the cylindrical portion 57 of the body 41 and a lower surface 161 in contact with the gasket 51 (FIG. 3) on the drain 29 of the steam trap 3. The sealing contact between the upper surface 159 of the flange 157 and the body 41 of the restricter forces steam in the manifold 71 to pass through the drain passage member 139 in the mating base 47.

As shown in FIG. 3, the lower portion 155 of the mating base 47 is sized and shaped for reception into the drain 29 of the steam trap 3. In the illustrated embodiment, the mating base 47 is removably attached to the cylindrical portion 57 of the body 41 so that the base may be readily replaced with a base sized to fit a specific size drain opening. For example, the mating base 47 may be replaced with a mating base having a lower portion with a smaller diameter D so that the base is sized to correspond with a steam trap 3 having a smaller drain (not shown). Alternatively, the mating base 47 may be replaced with a mating base sized to fit a larger drain (not shown).

A thermodynamic stop disk 175 is disposed in the cavity 89 and is supported by the top surface 59 of the cylindrical portion 57. As shown in FIGS. 5 and 6, the disk 175 has a top surface facing the top wall 77 of the cap 75 and a bottom surface in contact with the top surface 59 of the cylindrical portion 57 at a closed position of the disk (FIG. 5). The thermodynamic stop disk 175 is positioned for movement in the cavity 89 relative to the body 41 between an open position (shown in phantom in FIG. 5.) in which the stop disk permits fluid communication through the body from the second inlet passage member 103 to the drain outlet passage 135 and the closed position in which the stop disk blocks fluid communication from the second inlet passage to the drain outlet passage. In the closed position, the bottom surface of the stop disk 175 is seated against the top surface of the inner annular wall 111 of the cylindrical portion 57 of the body 41 to prevent the flow of fluid from the second inlet passage member 103 into the cavity 89. Also, the bottom surface of the thermodynamic stop disk 175 is seated against the top surface of the outer annular wall 115 of the cylindrical portion 57 to seal against the flow of fluid from the cavity 89 into the three cavity passage members 137. In the open position, the disk 175 is out of contact with the top surface 59 of the cylindrical portion 57 of the body 41 so that fluid can flow from the second inlet passage member 103 into the annular channel 129 of the cavity 89 and into the cavity passage members 137 opening to the manifold 71 at the bottom of the cylindrical body.

In one particular embodiment, the cylindrical portion 57 of the body 41 includes a condensate passage 181 comprising a fixed diameter orifice in the conical bottom wall 107 of the second inlet passage member 103. The condensate passage 181 is coaxial with second inlet passage member 103 and passes through the cylindrical portion 57 of the body 41 to the manifold 71. In the illustrated embodiment, the condensate passage 181 has a fixed diameter across the length of the passage. The diameter of the condensate passage 181 in the body 41 is selected based on the condensate load requirements of the specific application and should be sized to adequately drain an estimated ordinary quantity of condensate load. The condensate passage 181 is located in the conical bottom wall 107 at the low point of the inlet passage 95 in the steam restricter 1 whereby liquid that collects in the inlet passage will flow through the condensate passage to the drain outlet passage 135. Further, the position of the condensate passage 181 minimizes the occurrence of steam entering the passage because in normal operation liquid will collect on the conical bottom wall 107 of the second inlet passage member 103 and seal against the flow of steam through the condensate passage. In the event that steam enters the condensate passage 181, the steam will enter the manifold 71 which has a larger diameter than the condensate passageway. Once steam enters the manifold 71 from the condensate passage 181 it will expand and be more likely to condense into water prior to being released out the drain outlet passage 135.

The condensate passage 181 is sized for an expected constant load of condensate that enters the steam restricter 1. When the actual load is larger than the estimated load for which the condensate passage 181 is sized, condensate collects in the second inlet passage member 103 and begins to rise until the thermodynamic stop disk 175 is lifted. It is understood that the condensate passage 181 may be omitted from the steam restricter 1 of the present invention so that all liquid condensate passes through the second inlet passage member 103 and the three cavity passage members 137 of the drain outlet passage 135.

In use, the steam restricter 1 of the present invention allows condensate that collects in the steam trap 3 to drain to the outlet 29 of the trap and prevents steam from leaking from the steam system of the heater 7 through the steam restricter. As condensate collects in the steam trap 3, liquid will enter the first inlet passage members 99 and pass through the cylindrical portion 57 of the body 41 into the second inlet passage member 103. As liquid condensate fills the second inlet passage member 103 a small amount of liquid will pass through the condensate passage 181 in the conical bottom wall 107 of the second inlet passage. If a larger volume of liquid is received in the inlet passage 95 of the restricter, liquid will fill the second inlet passage member 103 and the thermodynamic forces in the body 41 cause the thermodynamic disk 175 to lift. When the thermodynamic disk 175 lifts, liquid will exit the second inlet passage member 103 and pass through the annular channel 129 forming the lower portion of the cavity 89 and into the cavity passage members 137. The condensate will flow through the cavity passage members 137 into the manifold 71 at the bottom of the cylindrical portion 57 of the body 41 and into the drain passage member 139 of the mating base 47. The mating base 47 is positioned in the drain 29 of the steam trap 3 so the condensate discharged from the steam restricter 1 enters the drain and the condensate return 15 attached thereto. In this way, condensate is allowed to exit the steam trap 3 through the steam restricter 1 while steam is prevented from passing through the restricter to the drain outlet 3. When the condensate has been drained through the drain outlet passage 135 of the restricter 1, steam will enter the cavity 89 which forces the thermodynamic disk 175 to close. It is understood that the disk 175 will cycle (raise and lower) based on the volume of condensate load received in the steam restricter 1.

The steam restricter 1 of the present invention is capable of operating efficiently over a wide range of load variations. A small constant load of condensate flows through the condensate passage 181 while larger fluctuations in condensate load pass through the inlet passage 95, cavity 89, and drain outlet passage 135 of the restricter 1. The modular design and interchangeability of the parts of the steam restricter 1 of the present invention allows the restricter to be modified to fit specific operating parameters. For example, the body 41 can be changed to increase or decrease the size of the condensate passage 181 if the constant condensate load of a specific application differs from what was expected for the application. Also, the mating base 47 can be changed to vary the diameter D of the lower portion 155 of the base to accommodate a variety of drain sizes. Further, the restricter 1 of the present invention with the first inlet passage members 99 being radial openings in the body 41 and the second inlet passage member 103 and three cavity passage members 137 being vertical openings, is compact so that the body has an overall size that may fit in a variety of existing steam traps 3.

The advantageous construction of the steam restricter 1 is illustrated by the method in which the device may be retrofitted to an existing steam trap 3. Prior to beginning the retrofitting operation, the particular steam system would be analyzed to determine the appropriate body 41 and mating base 47 for the particular operational characteristics (e.g., the expected condensate flow rates) of the steam system. The steam restricter 1 of the present invention requires less analysis of the existing steam system prior to the retrofitting operation because the steam restricter is capable of handling a range of condensate flow rates. To begin retrofitting the steam restricter 1, the cover 33 is unscrewed from the steam trap 3 and removed to expose the chamber 23. The existing steam restricter (not shown) is removed from the chamber 23. The steam restricter 1 is inserted into the chamber 23 with the lower portion 155 of the mating base 47 sliding into the drain 29. Insertion of the lower portion 155 into the drain 29 blocks communication from the chamber 23 to the condensate return 15 except through the steam restricter 1. The gasket 51 is positioned between the bottom surface 161 of the flange 157 of the mating base 155 and the drain 29 to seal the mating base in the drain. To secure the steam restricter 1 in the drain, a coil spring 53 of the type described above is selected from a plurality of coil springs having different relaxed lengths. The selected spring 53 will have a relaxed length greater than the vertical height between the top wall 77 of the cap 75 and the cover 33 of the steam trap 3. The lower end of the spring 53 is fitted on the cylindrical protrusion 91 of the cap 75 and the cover 33 is screwed back onto the bowl 21 of the steam trap 3. The spring 53 is then held in compression between the cover 33 and the cap 75 of the body 41 such that it exerts a force on the body of the steam restricter 1 that presses the outlet base 47 into sealing engagement with the gasket 51 mounted on the drain 29.

Maintenance of the steam restricter 1 consists of occasional cleaning of the annular filter 43 and condensate passage 181. The steam restricter 1 may be separated from the bowl 21 of the steam trap 3 by removing the cover 33 and lifting the steam restricter out of the chamber 23. After removing the gasket 51 and the mating base 47 from the body 41, the filter 43 may be slid off the body and blown clean. The condensate passage 181 as well as the first inlet passage members 99, second inlet passage member 103, and cavity passage members 137 of the cylindrical portion 57 of the body 41 may also be blown clean. The steam restricter 1 is reassembled and replaced in the chamber 23 by following the same steps described above for the initial retrofit of the restricter into the steam trap 3. Removal and replacement of the steam restricter 1 may be carried out without the use of any tools.

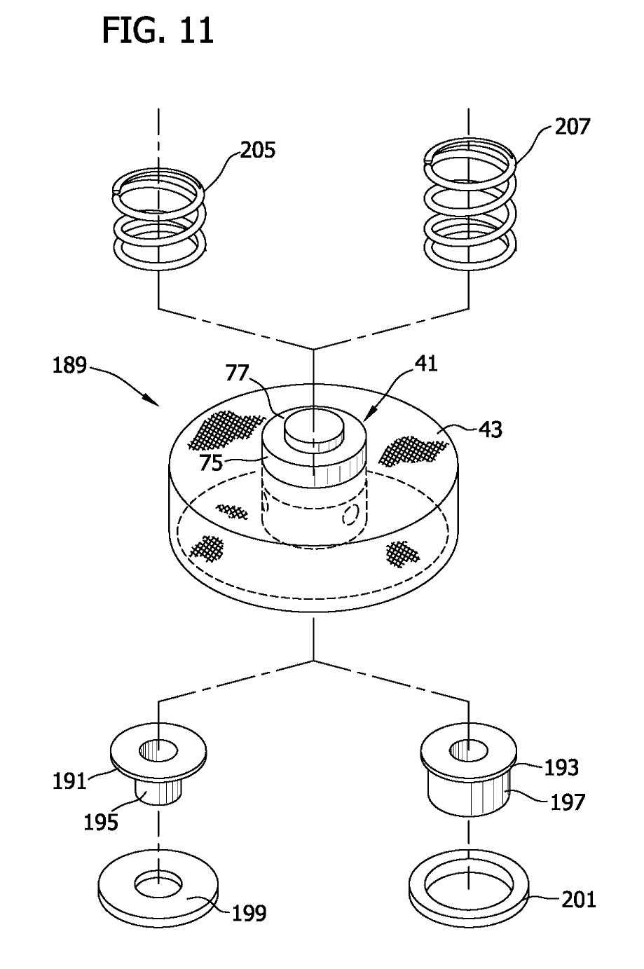

A steam restricter kit, generally indicated 189, for retrofitting a steam restricter is shown in FIG. 11 and includes the component parts of the steam restricter 1 shown in FIG. 4. In addition, the kit 189 includes a plurality of mating bases 191, 193 (two are shown) each having the same general configuration as the mating base 47 (FIG. 4), but having respective tubular portions 195, 197 with different outer diameters D1, D2. The kit 189 also includes a plurality of annular gaskets 199, 201 (two are shown) having internal diameters corresponding to the different outer diameters D1, D2 of the mating bases 191, 193. Using the kit 189 of the present invention, the retrofit of the steam restricter 1 to steam traps 3 which include drains 29 having outlets 31 of different sizes may be accomplished by selecting the mating base 191, 193 (and its corresponding gasket 195, 197) having the outer diameter D1 or D2 corresponding to the particular drain into which the lower portion 195, 197 of the mating base is inserted. Moreover, the kit 189 may include a plurality of coil springs 205, 207 (two are shown) having different relaxed lengths. The coil spring 205, 207 of the appropriate length may then be selected depending upon the vertical space between the cover 33 of the steam trap 3 and the top wall 77 of the cap 75.

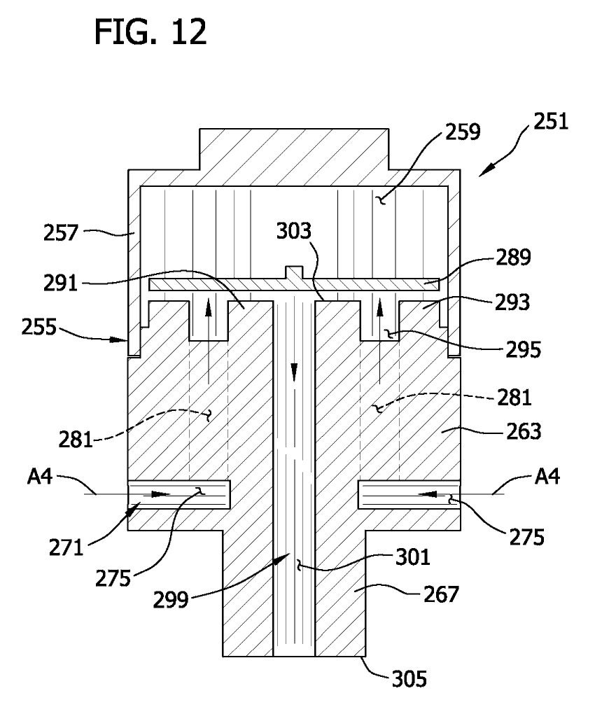

FIG. 12 illustrates an alternative embodiment of the steam restricter, generally indicated 251. As with the previous embodiment, the body, generally indicated 255, of the steam restricter 251 includes a cap 257 that defines a cavity 259 in the body and a lower cylindrical portion 263. In the embodiment of FIG. 12, the cylindrical portion 263 of the body 255 is formed integral with the mating base 267 of the steam restricter 251 that is received in the drain 29 (FIG. 3) of the steam trap 3. The inlet passage 271 of the steam restricter 251 includes a plurality of first (radial) passage members 275 (two are shown) above the mating base 267 and second (axial) passage members 281 each opening from a respective first passage member at one end and the cavity 285 at the other end. As in the previous embodiment, a thermodynamic stop disk 289 rests on the top surface of an inner annular wall 291 and the top surface of an outer annular wall 293 of the cylindrical portion 263. At the closed position of the disk 289, flow through the steam restricter 251 is prevented. The inner annular wall 291 and outer annular wall 293 of the cylindrical portion 263 are separated by an annular channel 295 forming the lower portion of the cavity 285. In the embodiment of FIG. 12, the drain outlet passage 299 comprises a central axial bore 301 of the cylindrical portion 263 that passes from the top surface 303 of the cylindrical portion to the bottom surface 305 of the mating base 267 so that fluid may flow from the cavity 285 through the drain outlet passage 299 and into the drain 3 of the steam trap 1.

In operation, the steam restricter 251 of FIG. 12 receives condensate flow into the inlet passage members 275 of the inlet passage 271 as indicated by arrows A4. As condensate flows into the restricter 251, fluid flows from the inlet passage members 275 into the axial passage members 281 of the inlet passage 271. As sufficient fluid enters the axial passage members 281, fluid fills the annular channel 295 of the cavity 285 and causes the thermodynamic stop disk 289 to raise from its closed position to its open position shown in FIG. 12. In the open position of the stop disk 289, fluid in the cavity 285 flows through the central axial bore 301 that passes from the cavity 285 to the bottom of the mating base 267 so that fluid exits the steam restricter 251 and enters the drain 3 of the steam trap 1.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that several objects of the invention are achieved and other advantageous results attained.

As various changes could be made in the above constructions without departing from the scope of the invention, it is intended that all matter contained in the above description or shown in the accompanying drawings shall be interpreted as illustrative and not in a limiting sense.

What is claimed is:

1. A steam restricter adapted to be retrofitted into an existing steam trap having a chamber, an inlet for admitting steam and condensate into the chamber and a drain for draining condensate from the chamber to a condensate return, the steam restricter comprising:
a body having an inlet passage positioned for opening to the chamber of the steam trap when installed in the steam trap;
a cavity in the body, the inlet passage in the body extending to the cavity;
a drain outlet passage extending from the cavity for passing condensate from the cavity to the drain of the steam trap when installed therein;
a thermodynamic stop disk disposed in the cavity for movement in the cavity relative to the body between an open position in which the stop disk permits fluid communication through the cavity from the inlet passage to the outlet passage and a closed position in which the stop disk blocks communication from the inlet passage to the outlet passage;
a mating base sized and shaped for connection to the drain of the steam trap so that passage of fluid in the steam trap to the drain is blocked except through the steam restricter when installed in the steam trap, the outlet passage extending through the mating base and opening into the steam trap drain when installed in the steam trap.

2. A steam restricter as set forth in claim 1 wherein the mating base is sized and shaped for reception into the drain of the steam trap.

3. A steam restricter as set forth in claim 2 wherein the mating base is generally tubular and projects from a bottom of the body.

4. A steam restricter as set forth in claim 3 wherein the mating base is removably attached to the body.

5. A steam restricter as set forth in claim 4 wherein the body comprises a cylindrical portion and a cap adapted for releasable connection to the cylindrical portion for defining the cavity.

6. A steam restricter as set forth in claim 3 wherein the outlet passage comprises plural cavity passage members, a manifold and a drain passage member, the cavity passage members extending separately from the cavity to the manifold and the drain passage member in the mating base extending from the manifold to a location opening to the exterior of the steam restricter.

7. A steam restricter as set forth in claim 6 wherein the inlet passage comprises first inlet passage members located for opening into the steam trap chamber when the steam restricter is installed in the steam trap, and a second inlet passage member in fluid communication with the first inlet passage members and opening into the cavity.

8. A steam restricter as set forth in claim 7 wherein the body is generally cylindrical and the first inlet passages extend generally radially of the body into the second inlet passage, the second inlet passage extending generally axially of the body.

9. A steam restricter as set forth in claim 8 wherein the manifold comprises a recess in an end of the body, the recess being closed by the mating base.

10. A steam restricter as set forth in claim 1 further comprising a fixed diameter condensate passage extending through the body and free of obstructions for communicating a minimum flow of condensate through the steam restricter.

11. A steam restricter capable of handling variable condensate loads, the steam restricter being compact for installation in confined spaces, the steam restricter comprising:
a body having a central axis and an inlet passage including first and second inlet passage members for receiving steam and condensate into the body;
a cavity in the body, the second inlet passage member extending parallel to the central axis of the body to a mouth where the second inlet passage member opens into the cavity;
a drain outlet passage including a drain passage member adapted for fluid communication with the cavity, the drain passage member extending parallel to the central axis of the body to a port, the cavity and port being at least partially in registration with each other along the central axis of the body;
a thermodynamic stop disk disposed in the cavity for movement relative to the body between an open position in which the stop disk permits fluid communication through the cavity from the second inlet passage member to the drain passage member and a closed position in which the stop disk blocks fluid communication from the second inlet passage member to the drain passage member.

12. A steam restricter as set forth in claim 111 wherein the drain outlet passage further comprises plural cavity passage members and a manifold, the cavity passage member extending from the cavity to the manifold and the drain passage member extending from the manifold to a location exterior of the steam restricter.

13. A steam restricter as set forth in claim 12 wherein the manifold and second inlet passage member each lie at least partially along a central axis of the body.

14. A steam restricter as set forth in claim 13 wherein the manifold and second inlet passage member are generally coaxial on the central axis of the body.

15. A steam restricter as set forth in claim 13 wherein the cavity passage members are located radially outward of the second inlet passage member.

16. A steam restricter as set forth in claim 15 wherein there are plural first inlet passage members extending into the second inlet passage member.

17. A steam restricter as set forth in claim 16 wherein the cavity passage members extend axially of the body and the first inlet passage members extend radially of the body past the cavity passage members.

18. A steam restricter as set forth in claim 11 further comprising a base, the drain passage member extending through the base.

19. A steam restricter as set forth in claim 18 wherein the base is removably mounted on the body and defines a boundary of the manifold in the body.

20. A steam restricter as set forth in claim 111 further comprising a fixed diameter condensate passage extending through the body and free of obstructions for communicating a minimum flow of condensate through the steam restricter.
